(19) United States
(12) Patent Application Publication
(10) Pub. No.: US 2011/0055402 A1
(43) Pub. Date: Mar. 3, 2011

(54) EXPOSING AUTOMATON INFORMATION BASED ON AGGREGATION OF MEMBER INFORMATION

(76) Inventors: Stéphane Cavin, Zurich (CH); Michael Trommsdorff, Zurich (CH)

(21) Appl. No.: 12/548,425

(22) Filed: Aug. 27, 2009

(51) Int. Cl. G06F 15/16

(52) U.S. Cl. 709/227; 709/238

(57) ABSTRACT

Architecture that exposes automaton information of an automaton based on aggregation of a set of member information and according to aggregation logic. The aggregation logic can include presence state, supported communications modalities, and time availability (e.g., business hours). The aggregation logic for presence state member information can be defined by the most available presence state of all persons the automaton it is hiding. The aggregation logic for capabilities member information can be the capabilities of the most available person the automaton is hiding. The aggregation logic for business hours member information can be defined by the largest interval possible covered by the persons hidden by the automaton. Other types of member information can be considered.

### BACKGROUND

Communications between users and user systems is essential in the business environment, as well as the personal environment. Time lost and the associated frustration when trying to contact another person can be exacerbated by the different types of devices employed, not knowing if the intended user is on site or away on vacation, and so on.

Presence is a standard mechanism by which information is given about an individual such as the ability and willingness of the individual to engage in a communication session. Presence can also include which communications modalities can be used for this communication. In existing communication systems no such information is available for hunt groups or any artificial identity hiding a set of members (e.g., persons) (referred to as an automaton). A caller may therefore contact a hunt group or automaton even though no member of that group is available/willing to communicate, thereby wasting the caller's time.

### SUMMARY

The following presents a simplified summary in order to provide a basic understanding of some novel embodiments described herein. This summary is not an extensive overview, and it is not intended to identify key/critical elements or to delineate the scope thereof. Its sole purpose is to present some concepts in a simplified form as a prelude to the more detailed description that is presented later.

The disclosed architecture collects member information about members of a group (e.g., telephony, text messaging, etc.) and surfaces that member information to facilitate communications with one or more of the group members. Where the group is members of a team, the architecture can route communications (e.g., voice/video call, messaging session, application sharing, etc.) to the team members based on information gathered about the team members, aggregation of the information, and exposure (e.g., publication) of the information for desired purposes. The group, also referred to as an automaton, has a set of information associated therewith that represents the member information about the members (e.g., persons) the automaton is hiding (or facading).

The architecture facilitates display of the automaton information based on an aggregation of a set of member information and applied aggregation logic. The aggregation logic can include presence state, supported modalities, business hours, and other information, for example. The architecture can give presence information about the automaton (or hunt group) which is representative of the state of the members of the group (presence aggregation).

To the accomplishment of the foregoing and related ends, certain illustrative aspects are described herein in connection with the following description and the annexed drawings. These aspects are indicative of the various ways in which the principles disclosed herein can be practiced and all aspects and equivalents thereof are intended to be within the scope of the claimed subject matter. Other advantages and novel features will become apparent from the following detailed description when considered in conjunction with the drawings.

### BRIEF DESCRIPTION OF THE DRAWINGS

FIG. 1 illustrates a computer-implemented automaton information system in accordance with the disclosed architecture.

FIG. 2 illustrates an alternative embodiment of an automaton information system.

FIG. 3 illustrates a generalization diagram of members and subgroups that can occur for automatons.

FIG. 4 illustrates a diagram of a member and associated member information.

FIG. 5 illustrates a diagram of aggregation of presence state as an attribute of the member information.

FIG. 6 illustrates a diagram of aggregation of communications modalities and presence state as attributes of the member information.

FIG. 7 illustrates a diagram of aggregation of time availability as an attribute of the member information.

FIG. 8 illustrates a method of providing information of an automaton.

FIG. 9 illustrates additional aspects of the method of FIG. 8.

FIG. 10 illustrates a block diagram of a computing system operable to aggregate and expose automaton information in accordance with the disclosed architecture.

### DETAILED DESCRIPTION

The disclosed architecture exposes automaton information of an automaton based on aggregation of a set of member information and according to aggregation logic. The aggregation logic can include, but is not limited to, presence state, supported communications modalities, and time availability (e.g., business hours).

The aggregation logic for presence state member information can be defined by the most available presence state of all persons the automaton is hiding. The aggregation logic for member capabilities information can be the capabilities of the most available person the automaton is hiding. The aggregation logic for member information related to member business hours can be defined by the largest interval possible covered by the persons (or members) hidden by the automaton. Other logic can be created and employed as well, and used for different member information attributes.

In one implementation, the disclosed architecture allows the automaton to subscribe/fetch the member information of all persons the automaton hides, aggregates this member information, applies a given aggregation logic (e.g., publishes automaton-specific business hours rather than user aggregated business hours), and publishes the aggregated information. The aggregation step can vary depending on the nature of the information.

Reference is now made to the drawings, wherein like reference numerals are used to refer to like elements throughout. In the following description, for purposes of explanation, numerous specific details are set forth in order to provide a thorough understanding thereof. It may be evident, however, that the novel embodiments can be practiced without these specific details. In other instances, well known structures and devices are shown in block diagram form in order to facilitate a description thereof. The intention is to cover all modifications, equivalents, and alternatives falling within the spirit and scope of the claimed subject matter.

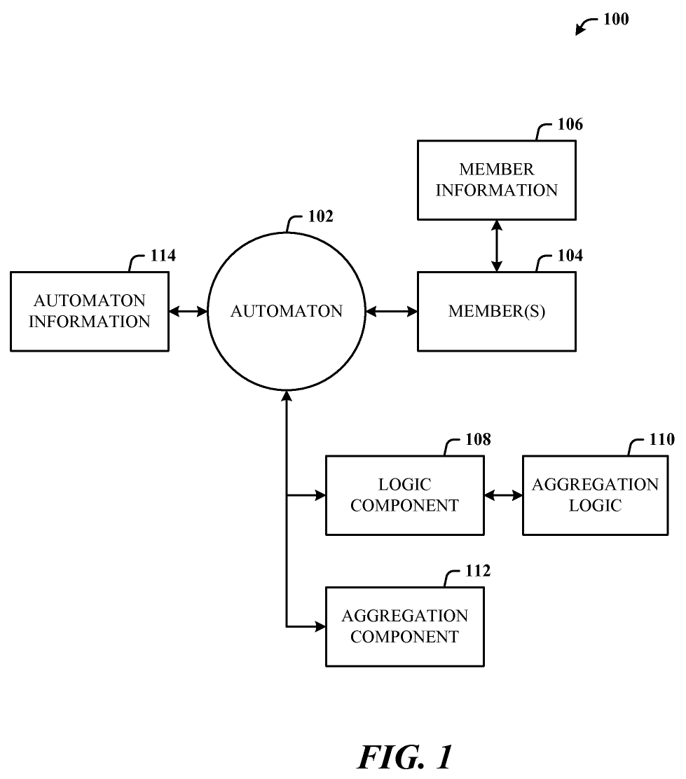

FIG. 1 illustrates a computer-implemented automaton information system 100 in accordance with the disclosed architecture. The system 100 includes an automaton 102 (e.g., of a communications framework) having one or more members 104 to which communications is intended. The one or more members 104 are associated with member information 106. Each of the member(s) 104 can be associated with its own member information 106. The member information 106 can include presence information, time availability information, capabilities information (e.g., communications modalities of the member client), and so on. These are only three examples of the member information 106, which can include other information such as user name, user level within an organization, member hardware and/or software capabilities, version information, etc., as desired.

The system 100 can further comprise a logic component 108 that includes aggregation logic 110 which can be applied to the member information. For example, the logic 110 can choose only the most available member of a subgroup of the automaton 102, the availability based on time such as from a calendar, or business working hours, holidays, travel availability, and so on. The number and composition of the aggregation logic 110 employed by the logic component 108 can be based on the types of member information 106 utilized. For example, if there are four types (or attributes) of member information 106, one type of aggregation logic 110 can process three types of the member information 106, while a second type of aggregation logic 110 can process only one type of the member information 106.

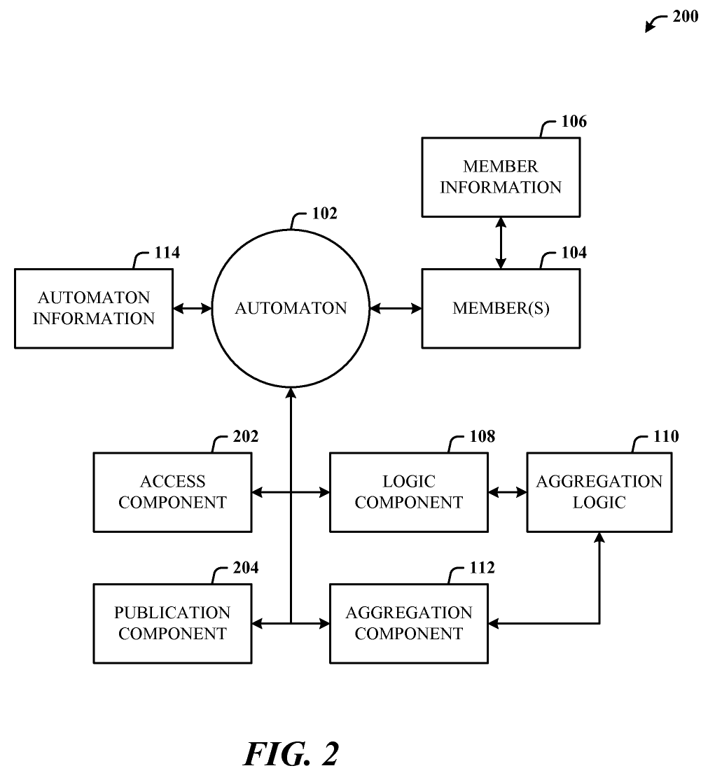

The system 100 can also comprise an aggregation component 112 that aggregates the member information 106 of the members 104 of the automaton 102. Aggregation can be performed separate from application of the aggregation logic 110 or aggregation can be performed using the aggregation logic 110. As illustrated, the aggregation logic 110 can be passed from the logic component 108 to the aggregation component 112 when needed. Alternatively, the aggregation component 112 can access the aggregation logic 110 directly (as shown in FIG. 2). The output of the aggregation process, and when according to the aggregation logic 110, is the creation of automaton information 114, which the automaton 102 exposes to facilitate the communications to an intended member or members 104. Aggregation can be performed over all automatons or a single automaton. Alternatively, aggregation can be performed only on specified automatons, thereby ignoring other automatons deemed not relevant.

The automaton 102 can be a set of persons or other entities (e.g., machines, programs) further defined according to teams or groups. Thus, if communications is intended to a person in the automaton 102, the automaton information 114 can be utilized to determine if communications can be accomplished immediately or at a later time, using time availability information (as included in the member information 106). In other words, the member information 106 includes user information about users, which are the one or more members 104 of the automaton 102.

Although not illustrated as such, the logic component 108 and aggregation component 112 can be solely affiliated with the automaton 102. Alternatively, the logic component 108 and aggregation component 112 can be associated with multiple automatons to process each automaton (e.g., automaton 102) and output the automaton information (e.g., automaton information 114) for each automaton according to a desired frequency (e.g., hourly, daily, etc.). The update frequency can also be triggered as soon as the lowest availability number of the presence state changes and at each change from within to outside (or outside to within), for example. Other triggers can be implemented as well.

The aggregation logic 110 can aggregate presence state of the one or more members 104 of the automaton 102. The aggregation logic 110 can also aggregate communications modalities supported by the one or more members 104 of the automaton 102, where the modalities can include at least one of voice communications, text communications, video communications, or application sharing. The aggregation logic 110 can additionally or separately aggregate time availability information of the one or more members 104 of the automaton 102. The automaton 102 obtains the member information 106 of all automaton members 104 and facilitates application of the aggregation logic 110 during aggregation using the logic component 108 and the aggregation component 112. Additionally, the automaton 102 exposes the automaton information 114 based on different selected criteria, such as a most available member for communications therewith, for example.

FIG. 2 illustrates an alternative embodiment of an automaton information system 200. The system 200 includes the components and entities of the system 100 of FIG. 1, and further comprises an access component 202 that accesses the member information 106 of automaton members 104. Access can be by subscription, fetch, or other similar techniques. Moreover, access can be performed at predetermined frequencies. Under the subscription technique, once subscribed, the member and/or group pushes the member information to the subscribing automaton 102. Under the fetch technique, the automaton 102 fetches or polls for the member information 106 from the member(s) and/or subgroups. This can be performed at predetermined frequencies as well.

A publication component 204 publishes the automaton information 114 to entities that consume such information. For example, the entities can include a presence framework that uses a portion of the automaton information 114 that is presence information. In other words, presence state can be part of the member information 106 for each of the member(s) 104 that is considered when intending to communicate with one or more members 104 of the automaton 102.

Put another way, an automaton information system 200 is provided that comprises the access component 202 (as part of the automaton 102) that accesses member information 106 of automaton members 104, the automaton 102 part of a communications framework, and the aggregation component 112 (as part of the automaton 102) that applies aggregation logic 110 during aggregation of the member information 106 to create automaton information 114. The aggregation component 112 exposes the automaton information 114 to facilitate communications with one or more members 104 of the automaton 102.

All or a portion of the member information is aggregated and exposed as presence information. The aggregation logic 110 includes at least one of presence state of the automaton members, communications modalities that can be accommodated by the automaton members, or time information related to accessing an automaton member. The aggregation component 112 computes presence state of the automaton 102 based on aggregation of presence state of the automaton members 104 using a most available presence state of all automaton members 104. The aggregation component 112 computes modality capability information of the automaton based on a most available member of all automaton members 104. The modality capability information includes at least one of voice communications, video communications, text communications, or application sharing.

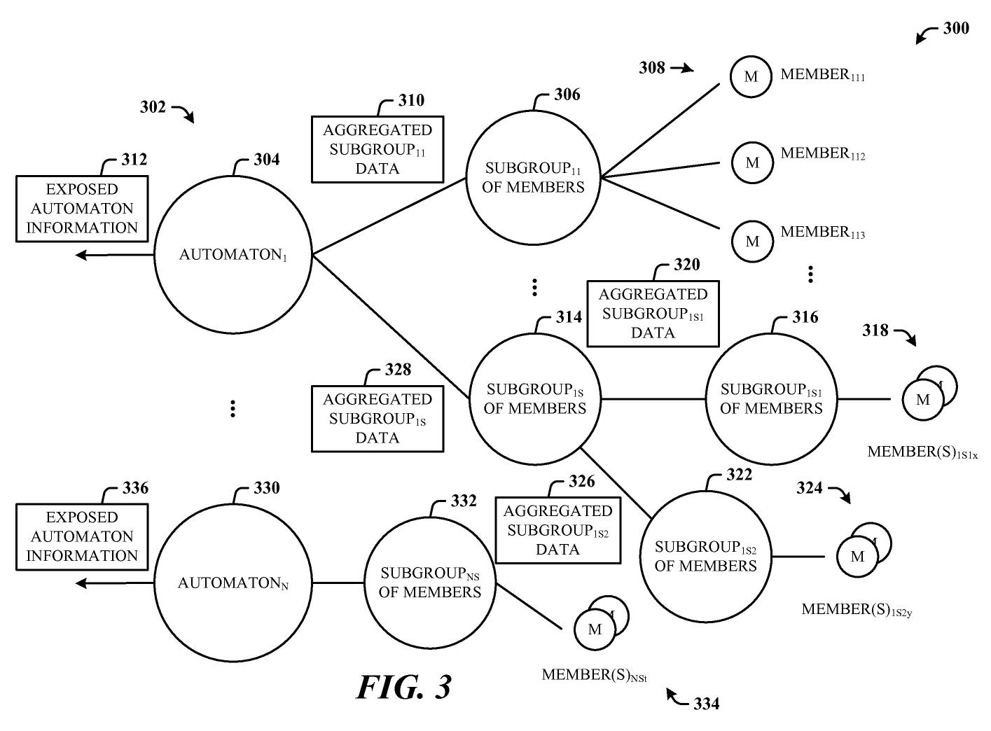

FIG. 3 illustrates a generalization diagram 300 of members and subgroups that can occur for automatons. For example, a communications system (e.g., diagram 300) can include multiple automatons 302, denoted Automaton_{1-N}. Here, a first automaton 304 includes four subgroups and members. A first subgroup 306 includes first subgroup members 308, three of which are illustrated. Each of the first subgroup members 308 has associated therewith member information (not shown). A subgroup can be a categorization or grouping of users, such as in teams, product groups, work units, or the like.

In another implementation, the members can be hardware or software groups into categories, domains, capabilities, or the like, for example. When performing aggregation of the subgroup member information of the first subgroup members 308, the member information can be aggregated according to a type of aggregation logic applied, thereby resulting in aggregated first subgroup data 310 from the first subgroup 306. The aggregated first subgroup data 310 will eventually be processed to output (expose) automaton information 312.

The first automaton 304 can also include a second subgroup 314, which further is a parent to a third subgroup 316. The third subgroup 316 has one or more third subgroup members 318 each having member information (not shown). When performing aggregation of the subgroup member information of the third subgroup members 318, the member information can be aggregated according to a type of aggregation logic applied, thereby resulting in aggregated third subgroup data 320 from the third subgroup 316 being passed to the second subgroup 314.

Similarly, the second subgroup 314 can be a parent to a fourth subgroup 322. The fourth subgroup 322 has one or more fourth subgroup members 324 each having member information (not shown). When performing aggregation of the subgroup member information of the fourth subgroup members 324, the member information can be aggregated according to a type of aggregation logic applied, thereby resulting in aggregated fourth subgroup data 326 from the fourth subgroup 322 being passed to the second subgroup 314. The second subgroup 314 is then processed using aggregation and aggregation logic to output aggregated second subgroup data 328.

The aggregated first subgroup data 310 and aggregated second subgroup data 328 are then processed by the automaton 304 to provide the overall exposed automaton information 312. It should be understood that the tree structure of the subgroups and members shown in diagram 300 is just one example of many types of structures that can exist and benefit from the automaton architecture disclosed herein. For example, the diagram 300 also shows an Nth automaton 330 having one or more subgroups 332 and associated subgroup members 334. The Nth automaton 330 exposes Nth automaton information 336 for use by consumers. It is to be appreciated that the automaton information 312 and the Nth automaton information 336 can be processed separately or together when attempting to communicate with automaton members.

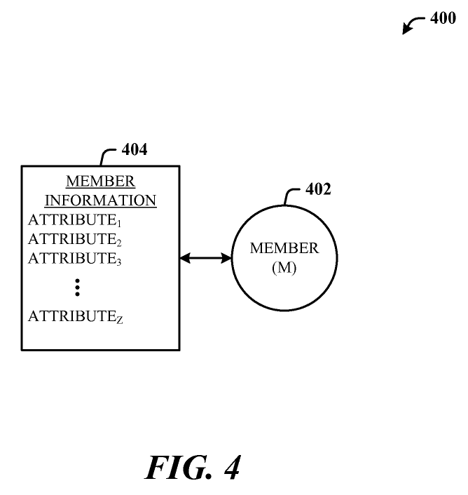

FIG. 4 illustrates a diagram 400 of a member 402 and associated member information 404. The member information 404 can include one or more attributes or properties related to time availability, presence state, communications modality capabilities, for example, and other attributes as desired. Aggregation logic can be run on one or more of the attributes of the member information 404 to arrive at a most available member (user), for example, for communications.

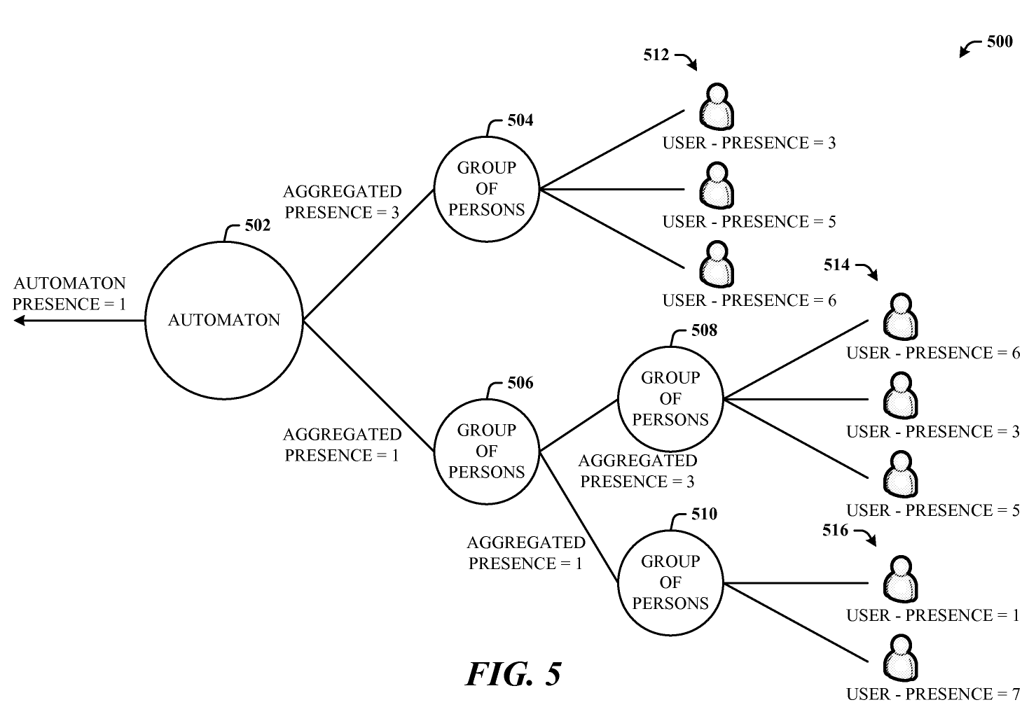

FIG. 5 illustrates a diagram 500 of aggregation of presence state as an attribute of the member information. An automaton 502 includes four subgroups of persons: a first subgroup 504, a second subgroup 506, a third subgroup 508, and a fourth subgroup 510. The first subgroup 504 has three member persons 512: a first person (user) having a presence state of three, a second person having a presence state of five, and a third person having a presence state of six.

The second subgroup 506 is a parent to the third subgroup 508 and the fourth subgroup 510. The third subgroup 508 has three member persons 514: a fourth person having a presence state of six, a fifth person having a presence state of three, and a sixth person having a presence state of five. The fourth subgroup 510 has two member persons 516: a seventh person having a presence state of one, and an eighth person having a presence state of seven. In this example, the smaller the presence state number, the more available the associated person is for communications.

The aggregation logic for this presence state example is that the automaton presence state is defined by the most available presence state of all persons the automaton 502 is hiding (or facading). When applying this logic to the first subgroup 504, the aggregation process outputs the most available person having the presence state of three. Similarly, the most available person of the third subgroup 508 has a presence state of three. The most available person of the fourth subgroup 510 has the presence state of one.

This aggregated presence information from the third subgroup 508 and fourth subgroup 510 is processed to output the user with the presence state of one from the second subgroup 506 to the automaton 502. The aggregated presence of three from the first subgroup 504 and the aggregated presence of one from the fourth subgroup 510 are then further aggregated using the logic to output the presence of one for the associated user from the automaton 502. Thus, in this example, communications will be enabled to the person having the presence state of one in the fourth subgroup 510. However, it is to be understood that member access is based on the routing logic employed that may use presence information differently. For example, if the routing logic indicates that any member having a presence state of three or less can be contacted, then communications can be obtained to any one or more of the qualifying members (having presence states of three and one).

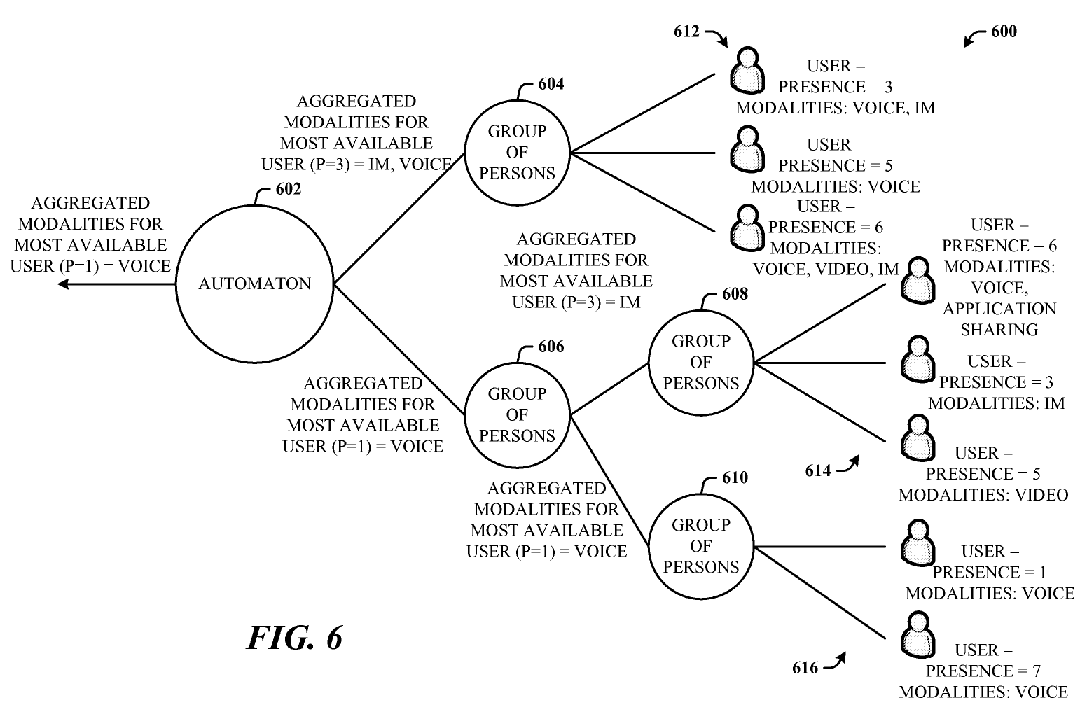

FIG. 6 illustrates a diagram 600 of aggregation of communications modalities and presence state as attributes of the member information. An automaton 602 includes four subgroups of persons: a first subgroup 604, a second subgroup 606, a third subgroup 608, and a fourth subgroup 610. The first subgroup 604 has three member persons 612: a first person (user) having a presence state of three and modalities of voice and instant messaging (IM), a second person having a presence state of five and a modality of voice only, and a third person having a presence state of six and modalities of voice, video, and IM.

The second subgroup 606 is a parent to the third subgroup 608 and the fourth subgroup 610. The third subgroup 608 has three member persons 614: a fourth person having a presence state of six and modalities of voice and application sharing, a fifth person having a presence state of three and a modality of IM only, and a sixth person having a presence state of five and a modality of video only. The fourth subgroup 610 has two member persons 616: a seventh person having a presence state of one and modality of voice only, and an eighth person having a presence state of seven and modality of voice only. In this example, the smaller the presence state number, the more available the associated person is for communications.

The aggregation logic for this mixed attribute example is that the automaton presence state is defined by the most available presence state of all persons the automaton 602 is hiding. The modality follows the most available person according to presence state.

When applying this logic to the first subgroup 604, the aggregation process outputs the most available person having the presence state of three having the modalities of voice and IM. Similarly, the most available person of the third subgroup 608 has a presence state of three and modality of IM. The most available person of the fourth subgroup 610 has the presence state of one and modality of voice. This aggregated presence information from the third subgroup 608 and fourth subgroup 610 is processed to output the user with the presence state of one and modality of voice from the second subgroup 606 to the automaton 602.

The aggregated presence of three and modalities of IM and voice from the first subgroup 604 and the aggregated presence of one and modality of voice from the fourth subgroup 610 are then further aggregated using the logic to expose the presence of one and modality of voice for the associated user from the automaton 602. Thus, in this example, communications will be to the person in the fourth subgroup 610 having the presence state of one and voice modality.

However, again, it is to be understood that member access is based on the routing logic employed that may use presence information and/or modality information differently. For example, if the routing logic indicates that any member having a presence state of three or less and voice modality can be contacted, then communications can be obtained to any one or more of the qualifying members (having presence states of three and one and voice modality).

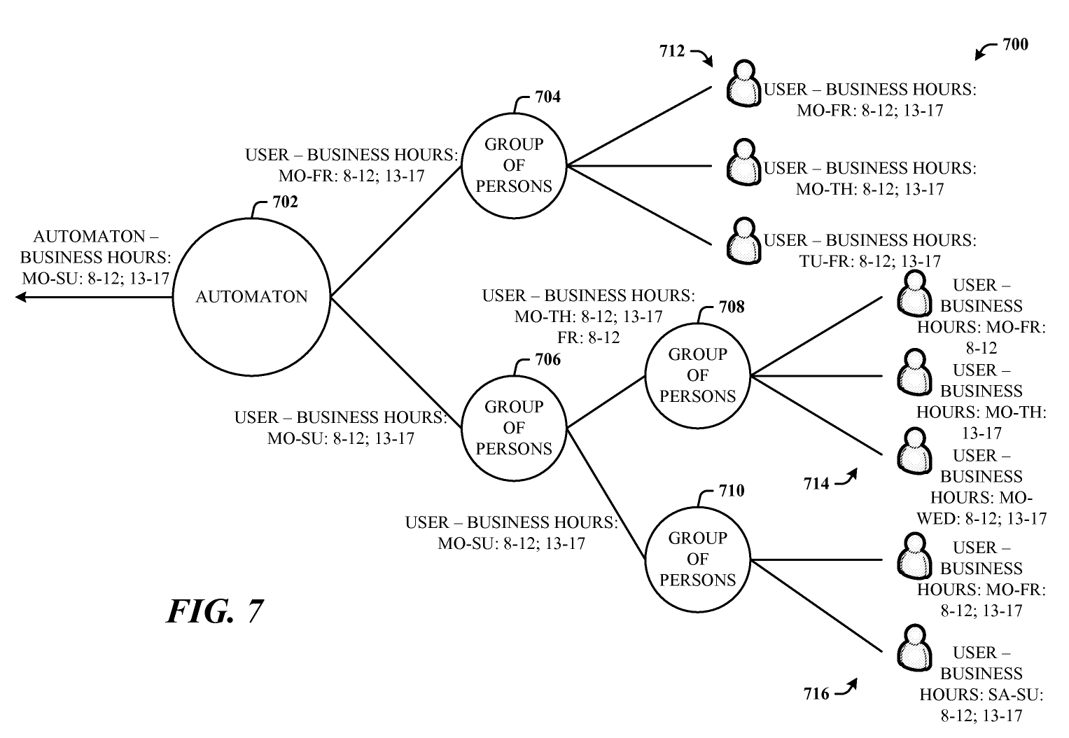

FIG. 7 illustrates a diagram 700 of aggregation of time availability as an attribute of the member information. An automaton 702 includes four subgroups of persons: a first subgroup 704, a second subgroup 706, a third subgroup 708, and a fourth subgroup 710. The first subgroup 704 has three member persons 712: a first person (user) having time availability in business hours from Monday-Friday, 8-12 and 13-17 (where hours are denoted on a military style 0-24 hour basis), a second person having time availability in business hours from Monday-Thursday, 8-12 and 13-17, and a third person having time availability in business hours from Tuesday-Friday, 8-12 and 13-17.

The second subgroup 706 is a parent to the third subgroup 708 and the fourth subgroup 710. The third subgroup 708 has three member persons 714: a fourth person having time availability in business hours from Monday-Friday, 8-12, a fifth person having time availability in business hours from Monday-Thursday, 13-17, and a sixth person having time availability in business hours from Monday-Wednesday, 8-12 and 13-17. The fourth subgroup 710 has two member persons 716: a seventh person having time availability in business hours from Monday-Friday, 8-12 and 13-17, and an eighth person having time availability in business hours from Saturday-Sunday, 8-12 and 13-17.

In this example, the aggregation logic applied is the business hours published by the automaton 702 defined by the largest interval possible covered by the persons hidden/facaded by the automaton 702. When applying this logic to the first subgroup 704, the aggregation process outputs the interval having the business hours of Monday-Friday, 8-12 and 13-17. Similarly, when applying this aggregation logic to the third subgroup 708, the aggregation process outputs the interval having the business hours of Monday-Thursday, 8-12 and 13-17, and Friday 8-12. When applying this aggregation logic to the fourth subgroup 710, the aggregation process outputs the interval having the business hours of Monday-Sunday, 8-12 and 13-17.

This aggregated business hour information from the third subgroup 708 and fourth subgroup 710 is processed to output the largest interval for the second subgroup 706 of Monday-Sunday, 8-12 and 13-17. The aggregated business hour information from the first subgroup 704 and second subgroup 706 are processed to expose the largest interval of the automaton 702 of Monday-Sunday, 8-12 and 13-17.

In a description more specific to presence, productivity of the IT worker can be improved by deploying departmental active call distribution (ACD) systems in accordance with the disclosed automaton architecture. For example, consider a basic call where a User1 needs IT Helpdesk support for a problem printer. User1 can enter “Helpdesk” in a search box and view “IT Helpdesk” in the search results. User1 notices that “IT Helpdesk” is an ACD and not a person, and is presented with the opening hours of the helpdesk and that the helpdesk is currently available. When User1 elects to call, a helpdesk person is the only agent available and receives the call. User1 can also be presented with information indicating that the call made by User1 was made outside opening hours of the helpdesk and that the helpdesk is currently offline.

With respect to hunt group availability, consider that User1 and User2 work for the Marketing department. User1 is offline and User2 is busy. User3 has a question, enters “marketing” in a search box, and views “marketing dept” in the search result. User3 can now be noticed that that “marketing dept” is busy.

In a large deployment of corporate ACD systems, each hunt group (or automaton) in the company can have a personal phone number and SIP (session initiation protocol) address, where company employees can join any member of a group. Only available agents get calls.

Included herein is a set of flow charts representative of exemplary methodologies for performing novel aspects of the disclosed architecture. While, for purposes of simplicity of explanation, the one or more methodologies shown herein, for example, in the form of a flow chart or flow diagram, are shown and described as a series of acts, it is to be understood and appreciated that the methodologies are not limited by the order of acts, as some acts may, in accordance therewith, occur in a different order and/or concurrently with other acts from that shown and described herein. For example, those skilled in the art will understand and appreciate that a methodology could alternatively be represented as a series of interrelated states or events, such as in a state diagram. Moreover, not all acts illustrated in a methodology may be required for a novel implementation.

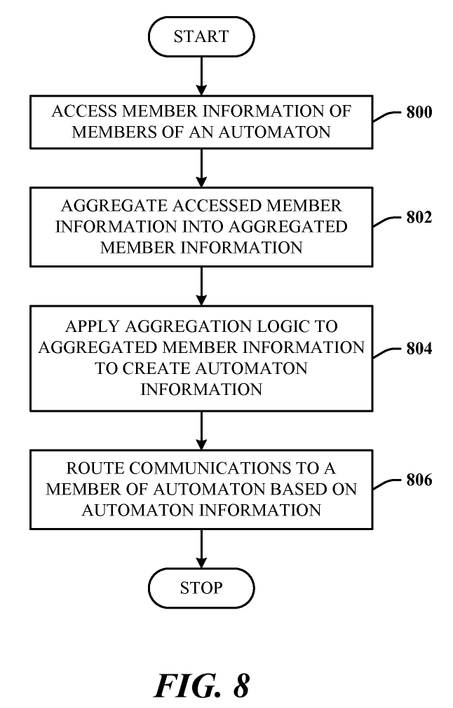

FIG. 8 illustrates a method of providing information of an automaton. At 800, member information of members of an automaton is accessed. At 802, the accessed member information is aggregated into aggregated member information. At 804, aggregation logic is applied to the aggregated member information to create automaton information. At 806, communications is routed to a member of the automaton based on the automaton information. Note that optionally, routing can also be based on routing logic that is different from the aggregation logic.

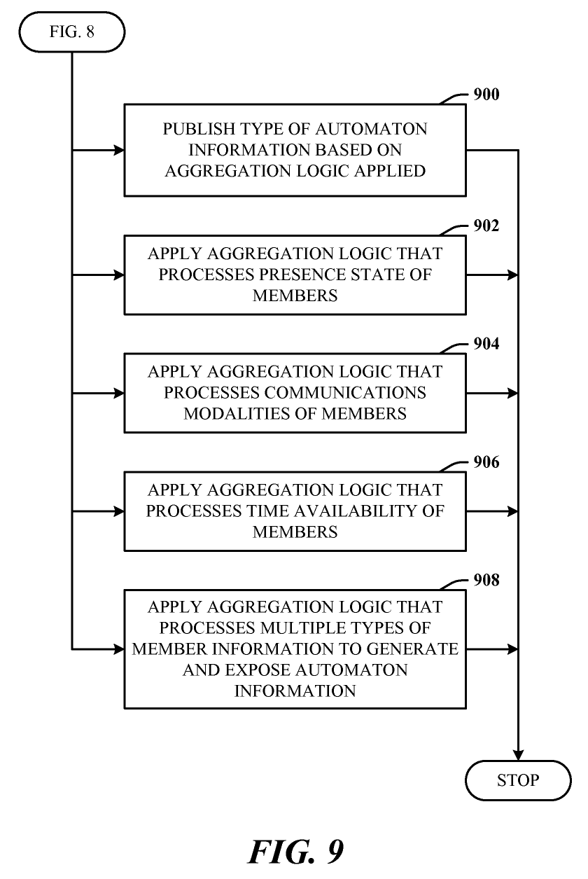

FIG. 9 illustrates additional aspects of the method of FIG. 8. At 900, a type of automaton information is published based on the aggregation logic applied. At 902, aggregation logic can be applied that processes presence state of the members. At 904, aggregation logic can be applied that processes communications modalities of the members. At 906, aggregation logic can be applied that processes time availability of the members. At 908, aggregation logic can be applied that processes multiple types of member information to generate and expose the automaton information.

As used in this application, the terms “component” and “system” are intended to refer to a computer-related entity, either hardware, a combination of hardware and software, software, or software in execution. For example, a component can be, but is not limited to being, a process running on a processor, a processor, a hard disk drive, multiple storage drives (of optical, solid state, and/or magnetic storage medium), an object, an executable, a thread of execution, a program, and/or a computer. By way of illustration, both an application running on a server and the server can be a component. One or more components can reside within a process and/or thread of execution, and a component can be localized on one computer and/or distributed between two or more computers. The word “exemplary” may be used herein to mean serving as an example, instance, or illustration. Any aspect or design described herein as “exemplary” is not necessarily to be construed as preferred or advantageous over other aspects or designs.

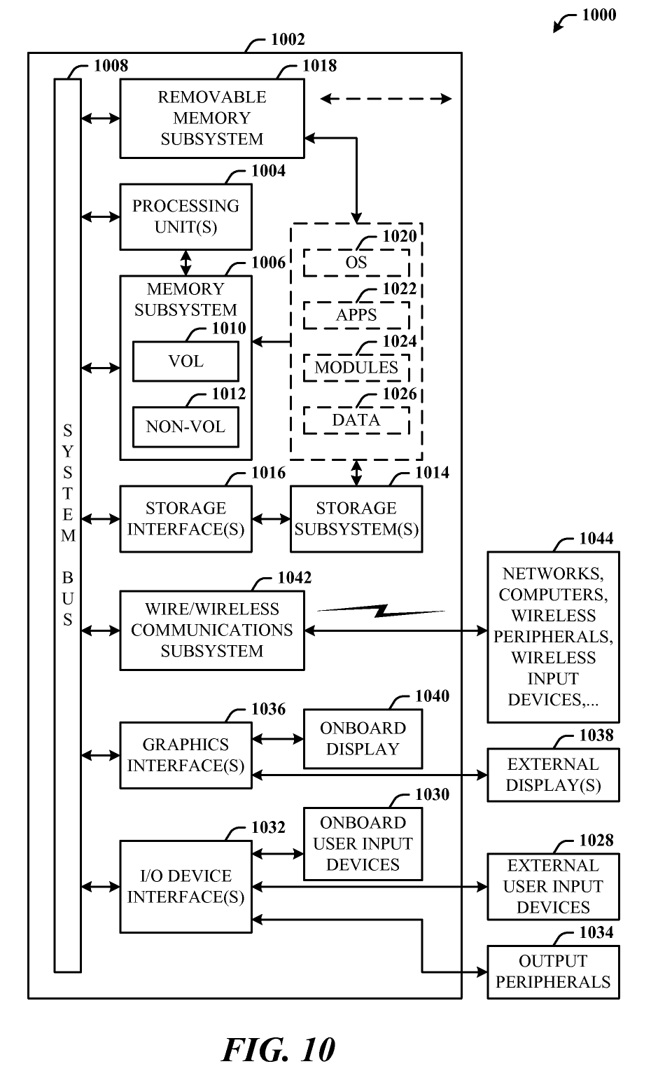

Referring now to FIG. 10, there is illustrated a block diagram of a computing system 1000 operable to aggregate and expose automaton information in accordance with the disclosed architecture. In order to provide additional context for various aspects thereof, FIG. 10 and the following discussion are intended to provide a brief, general description of the suitable computing system 1000 in which the various aspects can be implemented. While the description above is in the general context of computer-executable instructions that can run on one or more computers, those skilled in the art will recognize that a novel embodiment also can be implemented in combination with other program modules and/or as a combination of hardware and software.

The computing system 1000 for implementing various aspects includes the computer 1002 having processing unit(s) 1004, a system memory 1006, and a system bus 1008. The processing unit(s) 1004 can be any of various commercially available processors such as single-processor, multi-processor, single-core units and multi-core units. Moreover, those skilled in the art will appreciate that the novel methods can be practiced with other computer system configurations, including minicomputers, mainframe computers, as well as personal computers (e.g., desktop, laptop, etc.), hand-held computing devices, microprocessor-based or programmable consumer electronics, and the like, each of which can be operatively coupled to one or more associated devices.

The system memory 1006 can include volatile (VOL) memory 1010 (e.g., random access memory (RAM)) and non-volatile memory (NON-VOL) 1012 (e.g., ROM, EPROM, EEPROM, etc.). A basic input/output system (BIOS) can be stored in the non-volatile memory 1012, and includes the basic routines that facilitate the communication of data and signals between components within the computer 1002, such as during startup. The volatile memory 1010 can also include a high-speed RAM such as static RAM for caching data.

The system bus 1008 provides an interface for system components including, but not limited to, the memory subsystem 1006 to the processing unit(s) 1004. The system bus 1008 can be any of several types of bus structure that can further interconnect to a memory bus (with or without a memory controller), and a peripheral bus (e.g., PCI, PCIe, AGP, LPC, etc.), using any of a variety of commercially available bus architectures.

The computer 1002 further includes storage subsystem(s) 1014 and storage interface(s) 1016 for interfacing the storage subsystem(s) 1014 to the system bus 1008 and other desired computer components. The storage subsystem(s) 1014 can include one or more of a hard disk drive (HDD), a magnetic floppy disk drive (FDD), and/or optical disk storage drive (e.g., a CD-ROM drive DVD drive), for example. The storage interface(s) 1016 can include interface technologies such as EIDE, ATA, SATA, and IEEE 1394, for example.

One or more programs and data can be stored in the memory subsystem 1006, a removable memory subsystem 1018 (e.g., flash drive form factor technology), and/or the storage subsystem(s) 1014 (e.g., optical, magnetic, solid state), including an operating system 1020, one or more application programs 1022, other program modules 1024, and program data 1026.

The one or more application programs 1022, other program modules 1024, and program data 1026 can include the system 100 and components of FIG. 1, the system 200 and components of FIG. 2, the diagram 300 of FIG. 3, the diagram 400 of FIG. 4, the diagram 500 of FIG. 5, the diagram 600 of FIG. 6, the diagram 700 of FIG. 7, and the methods and steps represented by the flow charts of FIGS. 8 and 9, for example.

Generally, programs include routines, methods, data structures, other software components, etc., that perform particular tasks or implement particular abstract data types. All or portions of the operating system 1020, applications 1022, modules 1024, and/or data 1026 can also be cached in memory such as the volatile memory 1010, for example. It is to be appreciated that the disclosed architecture can be implemented with various commercially available operating systems or combinations of operating systems (e.g., as virtual machines).

The storage subsystem(s) 1014 and memory subsystems (1006 and 1018) serve as computer readable media for volatile and non-volatile storage of data, data structures, computer-executable instructions, and so forth. Computer readable media can be any available media that can be accessed by the computer 1002 and includes volatile and non-volatile media, removable and non-removable media. For the computer 1002, the media accommodate the storage of data in any suitable digital format. It should be appreciated by those skilled in the art that other types of computer readable media can be employed such as zip drives, magnetic tape, flash memory cards, cartridges, and the like, for storing computer executable instructions for performing the novel methods of the disclosed architecture.

A user can interact with the computer 1002, programs, and data using external user input devices 1028 such as a keyboard and a mouse. Other external user input devices 1028 can include a microphone, an IR (infrared) remote control, a joystick, a game pad, camera recognition systems, a stylus pen, touch screen, gesture systems (e.g., eye movement, head movement, etc.), and/or the like. The user can interact with the computer 1002, programs, and data using onboard user input devices 1030 such a touchpad, microphone, keyboard, etc., where the computer 1002 is a portable computer, for example. These and other input devices are connected to the processing unit(s) 1004 through input/output (I/O) device interface(s) 1032 via the system bus 1008, but can be connected by other interfaces such as a parallel port, IEEE 1394 serial port, a game port, a USB port, an IR interface, etc. The I/O device interface(s) 1032 also facilitate the use of output peripherals 1034 such as printers, audio devices, camera devices, and so on, such as a sound card and/or onboard audio processing capability.

One or more graphics interface(s) 1036 (also commonly referred to as a graphics processing unit (GPU)) provide graphics and video signals between the computer 1002 and external display(s) 1038 (e.g., LCD, plasma) and/or onboard displays 1040 (e.g., for portable computer). The graphics interface(s) 1036 can also be manufactured as part of the computer system board.

The computer 1002 can operate in a networked environment (e.g., IP-based) using logical connections via a wired/wireless communications subsystem 1042 to one or more networks and/or other computers. The other computers can include workstations, servers, routers, personal computers, microprocessor-based entertainment appliances, peer devices or other common network nodes, and typically include many or all of the elements described relative to the computer 1002. The logical connections can include wired/wireless connectivity to a local area network (LAN), a wide area network (WAN), hotspot, and so on. LAN and WAN networking environments are commonplace in offices and companies and facilitate enterprise-wide computer networks, such as intranets, all of which may connect to a global communications network such as the Internet.

When used in a networking environment the computer 1002 connects to the network via a wired/wireless communication subsystem 1042 (e.g., a network interface adapter, onboard transceiver subsystem, etc.) to communicate with wired/wireless networks, wired/wireless printers, wired/wireless input devices 1044, and so on. The computer 1002 can include a modem or other means for establishing communications over the network. In a networked environment, programs and data relative to the computer 1002 can be stored in the remote memory/storage device, as is associated with a distributed system. It will be appreciated that the network connections shown are exemplary and other means of establishing a communications link between the computers can be used.

The computer 1002 is operable to communicate with wired/wireless devices or entities using the radio technologies such as the IEEE 802.xx family of standards, such as wireless devices operatively disposed in wireless communication (e.g., IEEE 802.11 over-the-air modulation techniques) with, for example, a printer, scanner, desktop and/or portable computer, personal digital assistant (PDA), communications satellite, any piece of equipment or location associated with a wirelessly detectable tag (e.g., a kiosk, news stand, restroom), and telephone. This includes at least Wi-Fi (or Wireless Fidelity) for hotspots, WiMax, and Bluetooth™ wireless technologies. Thus, the communications can be a predefined structure as with a conventional network or simply an ad hoc communication between at least two devices. Wi-Fi networks use radio technologies called IEEE 802.11x (a, b, g, etc.) to provide secure, reliable, fast wireless connectivity. A Wi-Fi network can be used to connect computers to each other, to the Internet, and to wire networks (which use IEEE 802.3-related media and functions).

The illustrated aspects can also be practiced in distributed computing environments where certain tasks are performed by remote processing devices that are linked through a communications network. In a distributed computing environment, program modules can be located in local and/or remote storage and/or memory system.

What has been described above includes examples of the disclosed architecture. It is, of course, not possible to describe every conceivable combination of components and/or methodologies, but one of ordinary skill in the art may recognize that many further combinations and permutations are possible. Accordingly, the novel architecture is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A computer-implemented automaton information system, comprising:
an automaton of a communications framework having one or more members to which communications is intended, the one or more members associated with member information;
a logic component that includes aggregation logic which is applied to the member information; and
an aggregation component that aggregates the member information of the automaton according to the aggregation logic to create automaton information and exposes the automaton information to facilitate the intended communications.

2. The system of claim 1, wherein the member information includes user information about users, which are the one or more members of the automaton.

3. The system of claim 1, wherein the aggregation logic aggregates presence state of the one or more members of the automaton.

4. The system of claim 1, wherein the aggregation logic aggregates communications modalities supported by the one or more members of the automaton, the modalities include at least one of voice communications, video communications, text communications, or application sharing.

5. The system of claim 1, wherein the aggregation logic aggregates time availability information of the one or more members of the automaton.

6. The system of claim 1, wherein the automaton obtains the member information of all automaton members, facilitates application of the aggregation logic during aggregation using the logic component and the aggregation component, and exposes the automaton information based on a most available member for communications therewith.

7. The system of claim 1, wherein the automaton comprises a publication component that publishes the automaton information as presence information.

8. A computer-implemented automaton information system, comprising:
an access component of an automaton that accesses member information of automaton members, the automaton part of a communications framework; and
an aggregation component of the automaton that applies aggregation logic during aggregation of the member information to create automaton information, the aggregation component exposes the automaton information to facilitate communications with one or more members of the automaton.

9. The system of claim 8, wherein all or a portion of the member information is aggregated and exposed as presence information.

10. The system of claim 8, wherein the aggregation logic includes at least one of presence state of the automaton members, communications modalities that can be accommodated by the automaton members, or time information related to accessing an automaton member.

11. The system of claim 8, wherein the aggregation component computes presence state of the automaton based on aggregation of presence state of the automaton members using a most available presence state of all automaton members.

12. The system of claim 8, wherein the aggregation component computes modality capability information of the automaton based on a most available member of all automaton members.

13. The system of claim 12, wherein the modality capability information includes at least one of voice communications, video communications, text communications, or application sharing.

14. The system of claim 8, wherein the aggregation component computes time availability information of the automaton based on a largest time interval that includes time availability for all automaton members.

15. A computer-implemented method of providing information of an automaton, comprising:
accessing member information of members of an automaton;
aggregating the accessed member information into aggregated member information;
applying aggregation logic to the aggregated member information to create automaton information; and
routing communications to a member of the automaton based on the automaton information.

16. The method of claim 15, further comprising publishing a type of automaton information based on the aggregation logic applied.

17. The method of claim 15, further comprising applying aggregation logic that processes presence state of the members.

18. The method of claim 15, further comprising applying aggregation logic that processes communications modalities of the members.

19. The method of claim 15, further comprising applying aggregation logic that processes time availability of the members.

20. The method of claim 15, further comprising applying aggregation logic that processes multiple types of member information to generate and expose the automaton information.
